(19) United States
(12) Patent Application Publication
(10) Pub. No.: US 2008/0240230 A1
(43) Pub. Date: Oct. 2, 2008

(54) Media processor with an integrated TV receiver

(75) Inventors: Gedalia Oxman, Tel-Aviv (IL); Shay Landis, Hod-HaSharon (IL); Moshe Twito, Givat Shmuel (IL); Michael Khrapkovsky, Herzlia (IL); Amir Morad, Tel-Aviv (IL); Leonid Yavits, Herzlia (IL)

Correspondence Address: Martin D. Moynihan;PRTSI, Inc., P.O. Box 16446, Arlington, VA, 22215, US

(73) Assignee: Horizon Semiconductors Ltd., Herzlia (IL)

(21) Appl. No.: 11/730,070

(22) Filed: Mar. 29, 2007

(51) Int. Cl. H04N 11/04

(52) U.S. Cl. 375/240.01; 375/E07.001

(57) ABSTRACT

An integrated circuit for processing a media stream, including an RF input interface, an RF receiver unit configured for receiving an RF media stream from the RF input interface and extracting the media stream from the RF media stream, an input interface unit configured for receiving the media stream from a content source, a plurality of processing units, a switch, operatively connected to the RF receiver unit, to the input interface unit, and to each of the processing units, the switch configured to allow more than one of the operatively connected units to simultaneously receive the media stream, thereby allowing simultaneous processing of the media stream by the processing units, and an output interface, operatively connected to the switch, configured for outputting the simultaneously processed media stream. Related apparatus and methods are also described.

### FIELD OF THE INVENTION

The present invention relates to integrated hardware for TV receiving, demodulating, decoding, processing, and outputting, and more particularly, but not exclusively, to a System on Chip (SoC) with a number of processing units configured to enable simultaneous processing of media streams, and variants thereof.

### BACKGROUND OF THE INVENTION

During the last decade, service and content providers have encountered an increasing demand for high quality interactive video and audio content. This demand has led to wide development of digital terrestrial, satellite and cable TV infrastructures. In most cases, bandwidth required for transmission of such content far exceeds available bandwidth, such that data compression is necessary to meet the demand.

A TV signal may be understood as an analog radio frequency or intermediate frequency flow of data from a source to a receiver. The flow of data comprises a frequency, phase, amplitude, or otherwise, modulated carrier signal representing a plurality of audio channels, video channels, still images, text, graphical objects, instructions, control signals, and similar content.

A media stream, or media signal, may be understood as an analog or digital flow of data from a source to a receiver, the flow of data being similar to the flow of data described above.

A home gateway is typically a central set top box or some other electronic device, usually designed to produce output provided to a plurality of analog and digital television sets. The home gateway is typically connected to one or more communication channels such as a telephone, an optical fiber, ADSL, a wireless transmission, a Data Over Cable Service Interface Specifications (DOCSIS) cable modem, a content source, and so on.

A content source may be understood as an analog terrestrial TV feed, a digital terrestrial TV feed, a cable feed, a satellite feed, a digital versatile disc (DVD) player, a high density (HD)-DVD player, a Blu-Ray player/recorder, a camcorder, a hard disk, a digital video recorder (DVR), a personal recorder, a still camera, a place-shifting TV device, an external consumer electronic video appliance, a portable memory device, the Internet, a Local Area Network (LAN), a home network, a video cassette player and recorder (VCR), a telephone, a wireless media connection, and so on.

A processor or a processing unit may be understood as an execution unit, a processing unit that is available at a particular instant, a processing unit that is available when certain information of a processing procedure is presented thereto, a central processing unit, a designated processing unit, and so on.

Two significant types of user-end components used for receiving content from a content source, are a TV signal receiver and decoders.

The TV signal receiver is an electronic device which receives an analog RF signal, down-converts the analog RF frequency to an intermediate frequency (IF) analog TV signal, and demodulates the IF analog TV signal to a digital transport stream, or bit-stream. The TV receiver usually consists of a RF tuner, a Direct Current (DC) compensation unit, connected to an automatic gain control (AGC) unit, which is connected to a timing recovery unit, which is connected to a matched filter, which is connected to a phase locked loop unit, which in turn is connected to a Forward Error Correction (FEC) unit.

The decoder is an electronic device which decompresses and converts digital bit-streams into uncompressed streams, either digital or analog, for post-processing and display. The decoder usually consists of a digital stream acquisition device, which is connected to a demultiplexing device, which is connected to a video decoding device, an audio decoding device, or a combination thereof. The video decoding device is connected to a video output, either directly or through a blender device, which is designed to blend a plurality of video channels together with additional graphics.

An example decoder is described in U.S. patent application Ser. No. 11/603,199 of Morad et al. A drawback of the example decoder is a lack of direct TV receiving capability, which necessitates using an external TV receiver.

Persons skilled in the art will appreciate that integrating RF circuitry into a silicon chip is well-known in the art. One example of such a silicon chip is a Broadcom® BCM4501 Dual Advanced Modulation Satellite Receiver which combines a satellite RF tuner and a satellite demodulator produced by a standard CMOS process.

There is thus a widely recognized need for, and it would be highly advantageous to have, a compact and efficient decoder module with an integrated TV receiver functionality devoid of the above limitations.

The disclosures of all references mentioned above and throughout the present specification, as well as the disclosures of all references mentioned in those references, are hereby incorporated herein by reference.

### SUMMARY OF THE INVENTION

The present invention seeks to provide an improved multi-standard multi-channel media processor with an integrated TV receiver.

According to one aspect of the present invention there is provided an integrated circuit for processing a media stream, including integrally as a single unit an RF input interface, an RF receiver unit configured for receiving an RF media stream from the RF input interface and extracting the media stream from the RF media stream, an input interface unit configured for receiving the media stream from a content source, a plurality of processing units configured to simultaneously process the media stream, a switch, operatively connected to the RF receiver unit, to the input interface, and to each of the processing units, the switch configured to allow more than one of the operatively connected units to simultaneously receive the media stream and to simultaneously communicate with each other, and an output interface, operatively connected to the switch, configured to receive the processed media stream from the switch, and to output the processed media stream.

According to another aspect of the present invention there is provided a method for providing a processed media stream, including receiving an RF input from an RF content source, tuning and demodulating the RF input to produce a media stream, providing the media stream to a plurality of processing units, enabling the plurality of processing units to simultaneously process the media stream, enabling simultaneous communication between any two of the plurality of processing units, and outputting the processed media stream.

According to yet another aspect of the present invention there is provided a digital television system including an integrated circuit including an RF receiver configured to receive an RF signal including a media stream, and to produce a digital media stream, a plurality of processing units operatively connected to the RF receiver, configured for simultaneously processing the digital media stream, a switch, operatively connected to each of the plurality of processing units and to the RF receiver, configured to enable more than one of the operatively connected processing units to simultaneously receive the media stream, and an output interface operatively connected to the switch for outputting the simultaneously processed digital media stream.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified illustration of a functional relationship among electronic components of a media processor with an integrated TV receiver constructed and operative in accordance with a preferred embodiment of the present invention;

FIG. 2 is a simplified block diagram illustration of the media processor of FIG. 1;

FIG. 3 is a simplified block diagram illustration of a demodulator comprised in the media processor of FIG. 2;

FIG. 4 is a simplified block diagram illustration of an alternative preferred embodiment of the demodulator comprised in the media processor of FIG. 2;

FIG. 5 is a simplified block diagram illustration of an advanced digital set top box comprising the media processor of FIG. 1;

FIG. 6 is a simplified block diagram illustration of an advanced set top box combining analog and digital inputs, and comprising the media processor of FIG. 1; and

FIG. 7 is a simplified flowchart of an exemplary method for processing media streams, according to a preferred embodiment of the present invention.

### DESCRIPTION OF PREFERRED EMBODIMENTS

The present embodiments comprise an apparatus and a method for a multi-standard multi-channel media processor with an integrated TV receiver that is used, inter alia, for processing signals from one or more sources and for providing one or more outputs.

One preferred embodiment of the present invention is a set top box for receiving media streams. The media streams can be, by way of a non-limiting example, terrestrial, cable, and satellite TV signals, input from DVD and HD-DVD players and recorders, personal video recorders, portable video, audio players, and so on.

The set top box comprises a multi-standard, multi-channel media processor, designed for receiving media streams, such as, by way of a non-limiting example, TV signals from various sources, such as digital broadcasts, analog broadcasts, digital video recordings, analog video, and so on. The set top box's media processor receives, tunes, demodulates and decodes the media streams, and further deciphers, demultiplexes, decompresses, and plays back the media streams. The set top box's media processor implements any of a variety of decryption, decompression and video display processing methods. The set top box's media processor may further be used for decrypting and playing back encrypted media signals.

In some preferred embodiments of the present invention, the media streams are indexed, re-encrypted and transferred to external storage devices, such as, by way of a non-limiting example, memory or a hard disk drive (HDD), for later playback in a personal video recorder application.

The principles and operation of an apparatus and method for a multi-standard multi-channel media processor with an integrated TV receiver according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

The term “AV” in all its forms is used throughout the present specification and claims interchangeably with the terms “AV stream”, “audio visual”, “audio visual stream”, “video”, “video stream”, “audio”, “audio stream”, “media”, “media stream”, “TV signal”, and their corresponding forms.

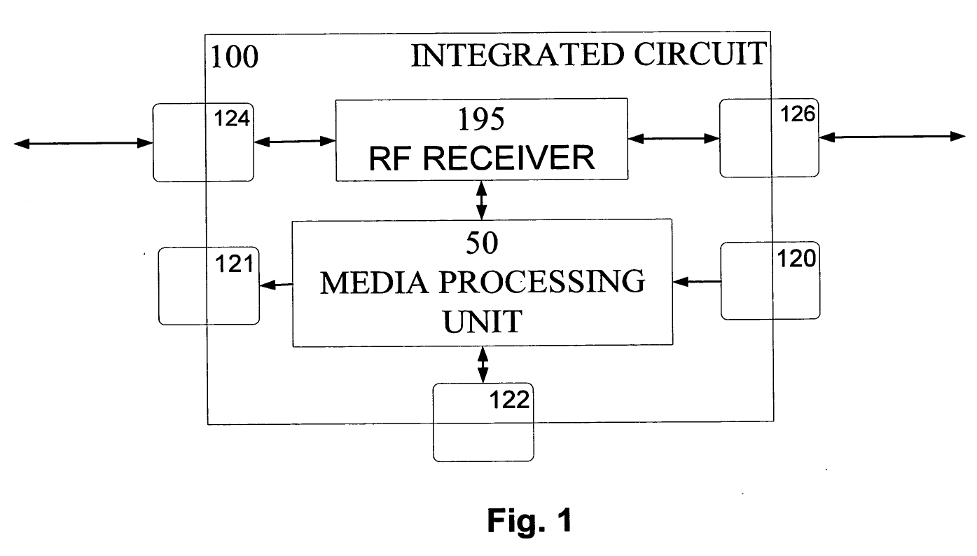

Reference is now made to FIG. 1, which is a simplified illustration of a functional relationship among electronic components of a media processor 100 with an integrated RF receiver 195 constructed and operative in accordance with a preferred embodiment of the present invention.

It is to be appreciated that the media processor 100 with an integrated RF receiver 195 of FIG. 1 is preferably implemented on a single integrated silicon chip.

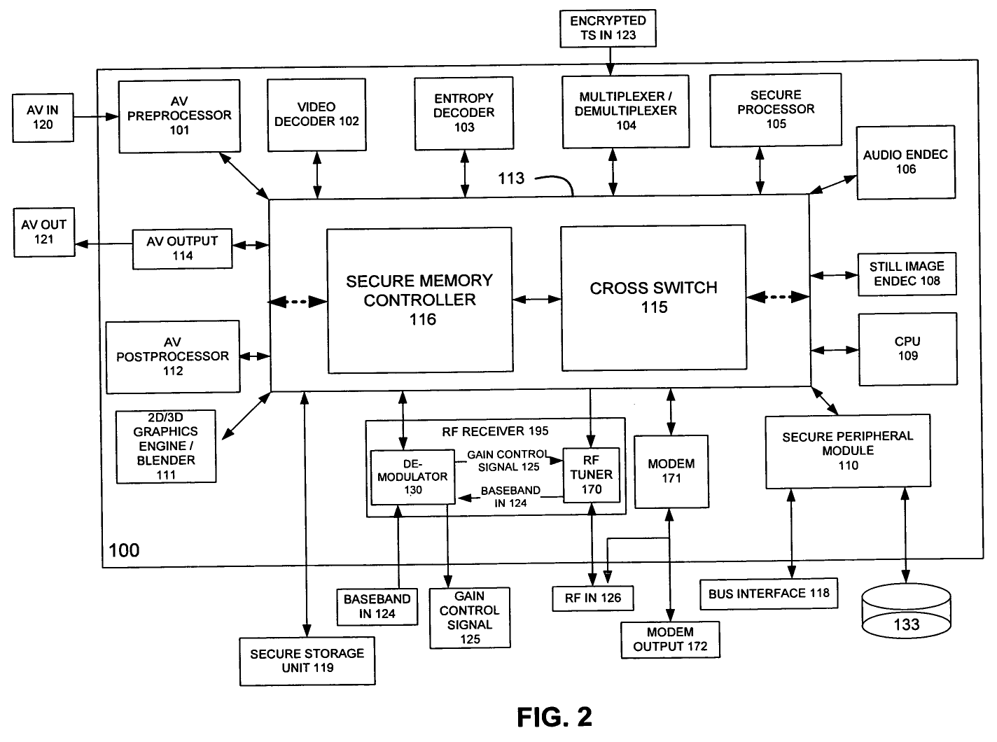

The media processor 100 comprises one or more RF inputs 126, for receiving input from a plurality of content sources (not shown). The RF inputs 126 are connected to the RF receiver 195, and the RF receiver 195 is connected to a media processing unit 50. The media processor 100 also comprises one or more baseband inputs 124 to allow receiving and processing of baseband TV signals from external RF tuners. The baseband inputs 124 are connected to the RF receiver 195 in a manner which will be described below with reference to FIG. 2.

The media processor 100 also comprises an uncompressed digital and analog audio video (AV) input interface 120 for receiving media streams from a plurality of content sources (not shown), an uncompressed digital and analog AV output interface 121, and one or more additional digital input/output interfaces 122. The uncompressed digital and analog AV input interface 120, the uncompressed digital and analog AV output interface 121, and the one or more additional digital input/output interfaces 122, are connected to the media processing unit 50.

The media processor 100 operates as a media encoding and decoding device which provides efficient processing of one or more media streams. Input of the media streams may come from a combination of the uncompressed digital and analog AV input interface 120, the digital input/output interfaces 122, the RF inputs 126, and the baseband inputs 124. Processing of multiple media streams by the media processor 100 is done simultaneously. One or more processed media streams are produced and output via the uncompressed digital and analog AV output interface 121 or the digital input/output interfaces 122.

Persons skilled in the art will appreciate that integrating RF circuitry into a silicon chip is well-known in the art.

Reference is now made to FIG. 2, which is a simplified block diagram illustration of the media processor 100 of FIG. 1. The media processor 100 comprises a cross switch 115 and a secure memory controller 116, operatively connected to various interfaces and processing units and to each other. It is to be appreciated that depicting all the connections of the cross switch 115 and the secure memory controller 116 in FIG. 2 would be confusing, and that therefore the cross switch 115 and the secure memory controller 116 are simply depicted bi-directionally connected to each other, and to a general envelope 113 which surrounds both and is depicted bi-directionally connected to the various interfaces and processing units.

It is to be appreciated that the media processor 100 is preferably implemented on a single integrated silicon chip.

The media processor 100 comprises the following interfaces, some of which were briefly described above with reference to FIG. 1:

the one or more RF inputs 126, operatively connected to the RF receiver 195;

the one or more baseband inputs 124, operatively connected to the RF receiver 195;

the uncompressed digital and analog AV input interface 120 for receiving media streams from a plurality of content sources (not shown);

the uncompressed digital and analog AV output interface 121;

an encrypted transport media input 123; and

a bus interface 118.

It is to be appreciated that the one or more additional digital input/output interfaces 122 referred to in FIG. 1 were a general reference additional digital input/output interfaces, and are not depicted in FIG. 2. The one or more additional digital input/output interfaces 122 of FIG. 1 comprise, by way of a non-limiting example, the encrypted transport media input 123, and the bus interface 118.

The cross switch 115 and the secure memory controller 116 are operatively connected to a plurality of processing units, comprising:

an audio/video (AV) preprocessor 101, operatively connected to the uncompressed digital and analog AV input interface 120;

a video decoder 102;

an entropy decoder 103;

a multiplexer/demultiplexer 104, operatively connected to the encrypted transport media input 123;

a secure processor 105;

an audio encoder and decoder (ENDEC) 106;

a still image encoder and decoder (ENDEC) 108;

a CPU 109;

a secure peripheral module 110 operatively connected to the bus interface 118 and to the HDD 133;

a 2D/3D graphics engine/blender 111;

an AV postprocessor 112;

a secure AV output 114, operatively connected to the uncompressed digital and analog AV output interface 121;

the RF receiver 195, comprising an RF tuner operatively connected to the one or more RF inputs 126, and a demodulator 130 operatively connected to the RF tuner 170 and to the one or more baseband inputs 124 and gain control signals 125; and

a modem 171, operatively connected to the one or more RF inputs 126 and to a direct modem output 172.

Typical operation of the media processor 100 of FIG. 2 is now described.

In a preferred embodiment of the present invention, the media processor 100 is operated in TV signal receiving, demodulating and decoding mode. An RF TV signal is delivered via terrestrial broadcast, cable broadcast, satellite broadcast, or over IP. The RF TV signal is normally an RF signal, transmitted at high carrier frequency.

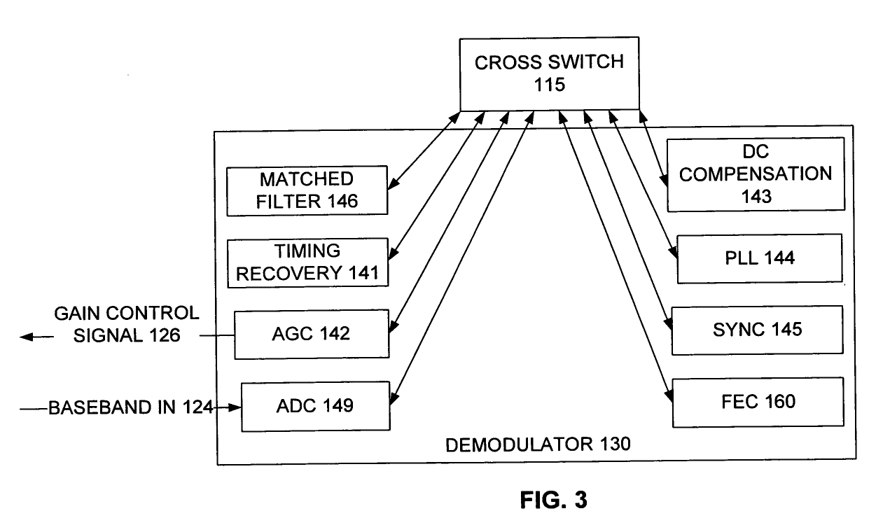

A first step of the receiving process is removing the carrier frequency and amplification of the TV signal, a process which is well known in the art and called tuning. The first step is performed by the RF tuner 170, or optionally by an external RF tuner (not shown). Amplification is normally an adaptive process controlled by an Automatic Gain Control unit 142, as described below with reference to FIG. 3. The outcome of tuning and amplification is an IF, or baseband, TV signal.

A second step of the receiving process comprises a demodulator 130 receiving the baseband TV signal and converting the baseband TV signal to digital transport streams, usually encrypted digital transport streams.

The encrypted digital transport streams are then transferred to the multiplexer/demultiplexer 104. Alternatively, the transport streams are acquired by the multiplexer/demultiplexer 104 from the encrypted transport media input 123, from the HDD 133, from the secure storage unit 119, or from the bus interface 118. The transport streams are first decrypted by the secure processor 105. The unencrypted transport streams are then preferably demultiplexed into separate compressed video and audio streams, still images and auxiliary data by the multiplexer/demultiplexer 104. The compressed video streams are further decompressed by the entropy decoder 103 and the video decoder 102, which generates reconstructed video streams. The reconstructed video streams are transferred to the AV postprocessor 112. Compressed audio streams are typically decompressed by the audio ENDEC 106, which generates a reconstructed audio signal. The reconstructed audio signal is transferred to the AV postprocessor 112. Compressed still images are preferably decompressed by the still image ENDEC 108, which generates reconstructed still images, which are transferred to the AV postprocessor 112. Graphics planes are typically generated by the 2D/3D graphics processor 111, and transferred to the AV postprocessor 112. Post-processed uncompressed video, still images, and graphic planes are preferably blended together into a single composite video signal, or a number of composite video signals. The resulting single or multiple composite video signals, along with associated audios, are typically transferred through the secure AV output 114, to the uncompressed digital and analog AV output interface 121.

The processing units will now be described in more detail.

The AV preprocessor 101 serves for performing various preprocessing procedures on incoming video. The AV preprocessor 101 typically receives input of one or more AV streams from the uncompressed digital and analog AV input interface 120, and from a secure storage unit 119 via the cross switch 115. The uncompressed digital and analog AV input interface 120 can be connected to one or more media sources, which simultaneously transmit media streams.

The input AV streams may be analog or digital, therefore, the AV preprocessor 101 preferably comprises an analog to digital converter (not shown), and an analog video decoder (not shown), for converting analog video into digital form, thereby producing a digital AV input.

The analog video decoder (not shown) comprises an analog front-end circuit, a synchronization circuit, a luma/chroma separation unit, a chroma demodulator and a back-end circuit. The AV preprocessor 101 preferably supports input of standard video interfaces, such as, by way of a non-limiting example, an S-video interface, a composite interface, a component interface, and a RGB interface.

The digital AV input preferably supports a standard digital AV interface, such as, by way of a non-limiting example, a CCIR656 interface, a digital video interactive (DVI) interface, a high-definition multimedia interface (HDMI), and other standards.

The preprocessor 101 preferably comprises an array of filters, enabling spatial and temporal filtering of the input AV signals, preferably motion-compensated filtering. Additional signal processing processes, such as, by way of a non-limiting example, analog noise reduction, digital noise reduction, linear and non-linear noise reduction, and video resolution change, are also preferably supported by the AV preprocessor 101. The AV preprocessor 101 preferably comprises analysis capabilities, such as, by way of a non-limiting example, scene change detection, zoom in/out detection, fade-in/out detection, 3:2 pull-down detection, and so on.

The preprocessed AV signals produced by the AV preprocessor 101 can preferably be transmitted to the secure storage unit 119 via the cross switch 115 and the secure memory controller 116.

It is to be appreciated that the AV preprocessor maintains bi-directional communication via the cross switch 115, for purposes such as, by way of a non-limiting example, setting parameters for preprocessing.

The multiplexer/demultiplexer 104 receives encrypted or non-encrypted compressed streams from the demodulator 130 via the cross switch 115 and from the encrypted transport media input 123, and demultiplexes the compressed streams, thereby generating demultiplexed compressed video, audio, still image, and auxiliary data streams. Preferably, the demultiplexed encrypted streams are transmitted to the secure processor 105 for decryption, preferably via the cross switch 115 or via a direct link (not shown).

The multiplexer/demultiplexer 104 preferably identifies which compression method was used to compress the separate compressed streams, and provides information about the compression method to the video decoder 102, to the entropy decoder 103, to the audio ENDEC 106, and to other units which require information about the compression method. The multiplexing is preferably done while maintaining lip-synchronization of the associated video signals and audio signals.

In a preferred embodiment of the present invention, several of the transport streams are indexed in a manner which enables implementation of trick mode playback, such as, by way of a non-limiting example, fast forward, fast backward, and slow motion. The transport streams are transferred, preferably after re-encrypting, to the external HDD 133 for storage and future decryption, demultiplexing, decompression and playback.

The indexing can be done according to frame type, by way of a non-limiting example, according to I-frames, P-frames, and B-frames of MPEG compression; according to frame number; and based on video content. Indexing based on video content is performed according to events such as, by way of a non-limiting example, detection and tagging of substantial movement, of a scene change, and so on. Indexing is preferably also performed according to user references, such as an EPG search, and EPG selection, channel selection, and so on. Preferably, meta-data relating to the media streams, such as tags and indexes, are associated with items in one or more frames. During trick mode playback, all frames tagged or indexed in a certain way are played. Playback of trick mode video preferably comprises playing back a portion of the frames of a video sequence, such as, by way of a non-limiting example, playing back a number of frames per scene, playing back every I-frame, and other trick mode playback schemes which are well known in the art. Preferably, trick mode playback supports using combinations of tags and indexes.

In an alternative preferred embodiment of the present invention, the multiplexer/demultiplexer 104 multiplexes and formats AV and data streams, thereby producing one or more multiplexed streams. The multiplexed streams are preferably in the form of an accepted standard, such as, by way of a non-limiting example, an MPEG2 transport stream, a program stream, IP packets, and a packet format defined by Internet Streaming Media Alliance (ISMA) specifications.

In an alternative preferred embodiment of the present invention, the multiplexer/demultiplexer 104, in conjunction with the secure processor 105, operates one or more external MCards and SCards, which are used in removable security schemes for encryption.

The secure processor 105 decrypts encrypted compressed streams according to a variety of encryption algorithms, and transfers the decrypted streams to the multiplexer/demultiplexer 104 and to other units, preferably via the cross switch 115, or via a direct link (not shown).

The secure processor 105 deciphers the encrypted compressed streams according to one or more encryption algorithms, and in accordance with a variety of security, copy protection, and Digital Right Management (DRM) schemes. It is to be appreciated that any of numerous decryption algorithms and ciphers such as CSS, AACS, ASE, DES, RC4, RSA, ECC and others may preferably be used to decrypt the encrypted streams. Encryption algorithms are well known in the art and will therefore not be described here in detail.

In an alternative preferred embodiment of the present invention, the secure processor 105 encrypts the streams according to an encryption algorithm, and in accordance with a variety of DRM schemes. It is to be appreciated that any of numerous encryption algorithms such as CSS, AACS, ASE, DES, RC4, RSA, ECC, and other encryption algorithms can be used to encrypt the streams.

The secure processor 105 preferably generates a plurality of distinct authentication keys, such as, by way of a non-limiting example, keys to be used exclusively by the secure memory controller 116. The secure processor 105 is preferably used to generate authentication keys for encrypting AV streams; for providing secure communication with the external HDD 133, the bus interface 118, and the secure storage unit 119; for copy-protecting output sent to the uncompressed digital and analog AV output interface 121, and so on. The authentication keys are preferably not constant, and are based, at least partly, on information kept on a secure One Time Programmable (OTP) memory, on information taken from external removable security devices such as smart cards, on other information taken from an embedded true random number generator (not shown), and so on. The authentication keys are preferably generated and transferred to applicable units of the media processor 100 directly, without intervention of the CPU 109 or other processors. The authentication keys are preferably stored in secure, non-accessible sections of the secure processor 105, such as, by way of a non-limiting example, in secure OTP memory, with an aim of preventing any access, disassembly, hacking, or other discovery of the authentication keys by hackers. Preferably, most of the authentication keys, except for, by way of a non-limiting example, HDCP™ (High-bandwidth Digital Content Protection) keys, are never exported or stored outside the secure processor 105.

The OTP memory (not shown) preferably stores predefined content which is programmed during an integrated circuit (IC) manufacturing process and therefore cannot be altered. Such a memory may be implemented, by way of a non-limiting example, as an anti-fuse memory. The OTP memory is designed according to known standards, such as commercially available CMOS logic process technologies. It is to be appreciated that, since anti-fuse programming does not rely on a stored charge, the anti-fuse programming does not produce a voltage contrast, thereby eliminating a weakness which could be exploited by hackers to decipher the programming. Likewise, it is not possible to see any change to the anti-fuse transistor material, even under a microscope. Therefore, it is not possible to use inductive, IR, or magnetic detection to read the predefined content of the OTP memory. The OTP is integrated into the chip, such that its content cannot be read by an external device, by any means, including reverse engineering and any other destructive or non-destructive methods.

Internal registers and memories, which are embedded into the media processor 100, can preferably only be accessed by an authorized device or by a program which is authorized by the authentication process. One purpose of such authorization is to protect keys and other secret security information from theft. Another purpose of such authorization is to protect media content from unauthorized distribution, usage or theft. Yet another purpose of the authentication process is to prevent unauthorized access to and unauthorized modification of contents of internal registers and memories of the media processor 100, which store parameters, firmware code, and software code. Preferably, data exchange, such as media content or control signal exchange between the media processor 100 and external peripheral devices, such as a HDD and external memory, is encrypted to prevent unauthorized access to such data.

Software and firmware of various media processor 100 units and the embedded CPU are preferably constantly and continuously authenticated during normal operations of the media processor 100, to verify that the software and firmware are authentic and do not originate from an unauthorized source.

The secure processor 105, and other parts of the media processor 100 which are involved in authentication, authorization, media stream decryption, external interfaces encryption, video and audio copy protection, and other security operations, are preferably physically inaccessible to external users. The protection of the above-mentioned parts of the media processor 100 from firmware and software control and modification to prevent theft or unauthorized usage of authorization keys and other secret information is preferably implemented in hardware. The hardware protection is preferably non-hierarchical, flattened and distributed, so that it would be substantially hard to identify individual registers and functional blocks by way of reverse engineering. The hardware protection is preferably implemented by at least the following measures. The first measure is to distribute protected components in an irregular manner in an integrated circuit, so as to confuse interpretation of the components by visual inspection. The second measure is to use lower-layer metal interconnects, by way of a non-limiting example, interconnects using metal one and metal two, for producing and for interconnecting the protected components, and to provide shielding by dense routing of higher layers of metal, by way of a non-limiting example, metal 3 through metal 9, above the lower-layer metal interconnects, to shield from reverse engineering by visual inspection.

In a preferred embodiment of the present invention, the secure processor 105 comprises an additional security element which is a Downloadable Conditional Access System (DCAS). The DCAS defines a standard for secure download of a specific Conditional Access client, which is a computer program for controlling DRM into an Open Cable Application Platform (OCAP) compliant consumer media device. DCAS is a component which eliminates a need for other embedded or removable security. DCAS provides security based, at least partly, on allowing a changing of an entire security structure through downloading new software into consumer media devices. If a particular encryption algorithm is compromised, the encryption algorithm can be replaced by another encryption algorithm. Additionally, DCAS-based devices may incorporate internal support for a kind of smart card, similar to SIM chips in a GSM cell phone, which identifies subscribers and provide further protection.

The secure processor 105 preferably contains a secure OTP, a secure boot loader, a secure storage segmentation and checking mechanism, a code authentication mechanism, a true random number generator, various ciphers, and other hardware based processors for generating and exchanging secure DRM keys with external security equipment and devices such as a smart card, a cable card, IEEE1394 DTCP (Digital Transmission Content Protection) based equipment, and so on.

The entropy decoder 103 receives compressed video bit-streams from the multiplexer/demultiplexer 104, preferably via the cross switch 115 or via a direct link (not shown). The entropy decoder 103 performs bit-stream decoding, entropy decoding and reconstruction of quantized transformation video coefficients. The entropy decoder 103 transmits the decoded video signals to the video decoder processor 102, preferably via the cross switch 115 or via a direct link (not shown).

Persons skilled in the art will appreciate that entropy encoding is a coding scheme that involves assigning codes to symbols so as to match code lengths with probabilities of symbols. Typically, entropy encoders are used to compress data by replacing symbols represented by equal-length codes with symbols represented by codes proportional to the negative logarithm of the probability of the symbols appearing in data. Therefore, most common symbols use the shortest codes.

The entropy decoder 103 preferably supports:

Context-Adaptive Binary Arithmetic Coding (CABAC), which is a technique of lossless compression of syntax elements in a video stream based on probabilities of syntax elements in a given context;

Context-Adaptive Variable-Length Coding (CAVLC), which is a lower-complexity alternative to CABAC for coding of quantized transform coefficient values; and

a common, simple, and highly-structured, variable length coding (VLC) technique for many syntax elements not coded by CABAC or CAVLC.

The video decoder 102 performs one or more video decompression sequences. The video decompression sequences performed by the video decoder 102 preferably comprise inverse quantization, DC/AC prediction, inverse spatial transformation, motion compensation, de-blocking filtering, de-ringing filtering, and other processing as required by compression algorithms with which a video stream was compressed. The video decoder 102 generates decompressed video streams and transmits the decompressed video streams to the AV postprocessor 112. The transmission is preferably made via a direct link (not shown), or via the cross switch 115.

If the compressed streams comprise audio streams, the multiplexer/demultiplexer 104 transmits the audio streams to the audio ENDEC 106, preferably via the cross switch 115 or via a direct link (not shown). The audio ENDEC 106 receives the audio streams and decompresses the audio streams in accordance with the audio compression algorithm which was used to compress the audio streams.

Various audio compression algorithms such as MPEG1, AC-3 (also known as Dolby Digital), AAC (Advanced Audio Coding), MP3. WMA (Windows Media Audio), DTS (Digital Theater System), and others may be used during audio decompression. The audio ENDEC 106 also preferably produces various audio effects such as, by way of a non-limiting example, down conversion of multi-channel audio into basic stereo, up-conversion of stereo audio into multi-channel audio, spatial effects, pseudo stereo, Dolby Prologic, QSound, Dolby Virtual Speaker, Virtual Dolby Surround, SRS, and so on.

The audio ENDEC 106 preferably implements audio control functions such as volume control, balance and equalization, bass and treble, loudness, and so on in accordance with control commands. The control commands are extracted from multiplexed compressed data streams by the data demultiplexer. The control commands may alternatively be received by the audio ENDEC 106 from the CPU 109, and from an external off-chip controller.

It is to be appreciated that the audio ENDEC receives information about the audio compression algorithm from the multiplexer/demultiplexer 104, as was described above with reference to the multiplexer/demultiplexer 104. The audio ENDEC 106 generates an audio signal, and transfers the audio signal to the AV postprocessor 112, preferably via the cross switch 115, or via a direct link (not shown).

In an alternative preferred embodiment of the present invention, the audio ENDEC 106 is operative to encode and transcoder, or convert, audio from one audio compression algorithm to the same audio compression algorithm with different encoding parameters, or from one audio compression algorithm to another audio compression algorithm, by way of a non-limiting example, from Dolby Digital Plus to Dolby Digital (AC-3).

If the compressed streams comprise still images, the media processor 100 transmits the compressed streams comprising the still images to the still image ENDEC 108, preferably via the cross switch 115, or via a direct link (not shown).

In a preferred embodiment of the present invention, compressed still images can also be received from, by way of a non-limiting example, the multiplexer/demultiplexer 104, the AV preprocessor 101, a digital camera, from an external device through the secure peripheral module 110, from external peripherals via a USB bus and the bus interface 118, and from the CPU 109.

The still image ENDEC 108 is designed to receive a bit-stream of still images, and to decompress the bit-stream and reconstruct the still images in accordance with a compression algorithm which was used to encode the still images. Image compression algorithms such as, by way of a non-limiting example, JPEG, Motion JPEG, GIF, and PNG are supported, and are well known in the art, and will therefore not be described here in detail.

The reconstructed still images are preferably transmitted to the AV postprocessor 112, preferably via the cross switch 115, or via a direct link (not shown).

In an alternative preferred embodiment of the present invention, the still image ENDEC 108 is operative to compresses still images according to a still image compression algorithm. The still image ENDEC 108 preferably transmits the compressed images to the multiplexer/demultiplexer 104, or to the CPU 109, preferably via the cross switch 115, or via a direct link (not shown).

The CPU 109 provides computational power to the media processor 100. The computational power is used for implementing user applications, for support and control of different functions comprised in the media processor 100, and optionally for support and control of external units such as the external HDD 133, and of external buses via the secure bus interface 118. The CPU 109 supports application software such as, by way of a non-limiting example, interactive gaming software, Voice over IP (VoIP) software, Video On Demand (VOD) software, DOCSIS media access control layer, trick mode support software, DRM key exchange software, encryption software, decryption software, DVD navigation software, and so on.

The embedded CPU 109 is designed to receive external control signals containing, by way of a non-limiting example, boot codes, interrupts, and software commands, from various sources. The various sources can be, by way of a non-limiting example, an external secure memory (not shown), non-volatile flash memory (not shown), read only memory (ROM) (not shown), the external HDD 133 via the secure peripheral module 110, the embedded secure peripheral module 110, and the cross switch 115.

The CPU 109 preferably features a fast arithmetic logic unit, intelligent caches, floating point support, and additional advanced features as are well known in the art.

In an alternative preferred embodiment of the present invention, the embedded CPU requires the connected external memory or flash memory device to initialize its operating system. Such initialization is secured using known methods, such as secure boot loader, symmetric and asymmetric code signing, and code encryption. Software modules, which are uploaded to the embedded CPU, are encrypted in order to prevent unauthorized access to the software modules.

The secure peripheral module 110 acts as a bridge, providing a secure connection between units within the media processor 100 and external devices. The external devices include, by way of a non-limiting example, standard industry buses, electronic appliances, and so on.

The secure peripheral module 110 preferably supports glue-less connectivity, via the secure bus interface 118, to a variety of industry standard external busses, such as, by way of a non-limiting example, a Universal Serial Bus (USB), a peripheral component interconnect (PCI) bus, a PCI-express bus, an IEEE-1394 Firewire bus, Ethernet & Giga-Ethernet (MII, GMII) buses, and so on.

The secure peripheral module 110 also supports a glue-less connection to devices such as, by way of a non-limiting example, an external HDD 133, an external DVD, a HD-DVD, and a Blu-Ray disk, preferably via a standard connection. The standard connection can be, by way of a non-limiting example, an integrated drive electronics (IDE) connection, an Advanced Technology Attachment (ATA) connection, an ATA Packet Interface (ATAPI) connection, a Serial ATA (SATA) connection, and a SATA II connection.

The secure peripheral module 110 also preferably supports various connections to a home networking system, such as, by way of a non-limiting example, a Multimedia over Coax Alliance (MOCA) connection, phone lines, power lines, and so on.

The secure peripheral module 110 also supports a number of low speed peripheral interfaces such as a universal asynchronous receiver/transmitter (UART), Integrated-Integrated Circuit (I2C), IrDA, Infra Red (IR), Standard Product Interface (SPI), a serial signal interface (SSI), Smartcard, and so on.

The 2D/3D graphics engine/blender 111 generates 2D and 3D graphic planes, and combines (blends) portions, or all of the graphic planes together. The graphic planes, or layers, may comprise text, drawings, 2D and 3D images, 2D and 3D animation, Internet pages, interactive menus, 2D and 3D electronics game screens, and so on.

The generating and the blending are based, at least in part, on control signals received from the multiplexer/demultiplexer 104, from the CPU 109, from an external controller connected to the secure bus interface 118, and other controlling units. Control commands which are received from the multiplexer/demultiplexer 104 are preferably extracted from multiplexed compressed data streams by the multiplexer/demultiplexer 104.

The 2D/3D graphics engine/blender 111 is a graphics processor designed for generating high-resolution 2D and 3D graphics in real time. The 2D/3D graphic engine/blender preferably performs designated graphics operations such as, by way of a non-limiting example, generating raster graphic objects and Bit Block Transfer (BLT).

Preferably, the 2D/3D graphics engine/blender is designed for generating a composite video layout that combines several of the following: video streams, still images and graphic planes. The composite video streams may originate from uncompressed and decompressed digital video streams. In some embodiments of the invention, an Alpha blending scheme is used to generate the composite video layout. Alpha blending is a scheme for making a foreground object in an image fade, so that an object behind the foreground object is seen through the foreground object.

Output of the 2D/3D graphics engine/blender 111 is typically transmitted to the AV postprocessor 112, preferably via the cross switch 115 or a direct link.

The AV postprocessor 112 performs multi-stream video post-processing sequences, such as, by way of a non-limiting example, image scaling, letter box detection, de-blocking, de-ringing, noise reduction, edge enhancement, image scaling, image de-blurring, dithering, moire cancellation, digital contour removal, motion stabilization, de-interlacing, inverse 3:2 and 2:2 pull-down detection, frame rate conversion, frame interpolation, and any combination thereof, as well as blending of multi-plane multi-stream video, data, text, still images, and graphics. The text can comprise, by way of a non-limiting, typical example, HTML.

In a preferred embodiment of the present invention, an alpha blending scheme is used to generate the composite video layout.

The AV postprocessor 112 also performs post-processing of audio sequences, such as, by way of a non-limiting example, audio enhancement, multi-stream audio blending, audio watermarking, and so on.

The AV postprocessor 112 preferable transmits post-processed AV signals to the secure AV output 114.

In a preferred embodiment of the present invention, all audio processing is performed by the audio ENDEC 106, and the audio signal passes directly from the audio ENDEC 106 to the secure AV output 114, preferably via the cross switch 115 or via a direct link (not shown).

In an alternative preferred embodiment of the present invention, video and audio signals are transferred from an external video source, via the uncompressed digital and analog AV input interface 120, through the AV preprocessor 101, to the AV postprocessor 112. The video and audio signals are preferably transferred via the cross switch 115, or via a direct link (not shown). The AV postprocessor 112 typically produces a composite video signal by blending graphic planes produced by the 2D/3D graphics engine/blender 111 with pre-processed uncompressed video signals received from an external video source. The composite video signal is transmitted to the secure AV output 114, preferably via the cross switch 115, or via a direct link (not shown).

The secure AV output 114 receives a plurality of AV streams, typically from the AV postprocessor 112. The secure AV output 114 outputs the AV streams in digital form, converts some or all of the AV streams to analog form using one or more analog to digital converters, and outputs the analog AV streams, or performs a combination thereof.

The secure AV output 114 preferably further implements one or more copy protection schemes. By way of a non-limiting example, for digital AV streams, a copy protection scheme such as a HDCP™ for HDMI (High Definition Multimedia Interface) is implemented. For analog video streams, copy protection schemes such as Macrovision™ or Dwight Cavendish System (DCS) copy protection are preferably implemented. For analog audio streams, a copy protection scheme such as Verance audio watermarking is preferably implemented. It is to be appreciated that any other copy protection scheme can also be implemented.

The uncompressed digital and analog AV output interface 121 typically transmits the plurality of AV streams to an external display device or to a sound device, after being authorized, and after one or more of the above-mentioned copy protection schemes have been implemented.

The cross switch 115 enables data communication between any two units of the media processor 100. The cross switch 115 allows any two units to communicate with each other in a bidirectional point-to-point interface, Preferably, several or all pairs of units are allowed to communicate with each other simultaneously using the cross switch 115. The communication of one pair of units is done without disrupting the communication of any other pair of units.

In a preferred embodiment of the present invention, a unit which initiates transmission can preferably transmit to multiple receiving, or target, units.

The cross switch 115 enables simultaneous transmission of commands and transfer of data from a number of initiating units and replies from a number of target units. The cross switch 115 preferably comprises an N-to-N interconnecting bus which enables use of a parallel access path between a plurality of initiating and a plurality of target units in the media processor 100. The interconnection bus provides multiple advantages, such as, by way of a non-limiting example, a significant increase in overall data throughput, software flexibility, and so on. In addition, the architecture of the media processor 100 can be upgraded by adding additional peripheral units without incurring performance degradation, as each unit connects to the cross switch 115. The interconnecting bus system is realized by using an interconnection matrix.

By way of a non-limiting example, the AV preprocessor 101, which functions as an initiating unit, may transfer video streams to the video decoder 102, which functions as a target unit. At the same time, the secure processor 105 and the still image ENDEC 108, which function as initiating units, can transmit a decrypted stream and a still image, respectively, to the multiplexer/demultiplexer 104 and to the 2D/3D graphics engine/blender 111.

The cross switch 115 is designed to manage a queue of requests for data and memory accesses, allowing a number of units to communicate with a common unit, as further described below.

The cross switch 115 reduces the number of local-bus-interfaces between units, and creates a socket for inter-connectivity. However, in alternative preferred embodiments of the present invention, and without loss of generality, the media processor 100 has direct local bus interconnectivity between some of the processing units, in addition to interconnectivity via the cross switch 115.

In yet another preferred embodiment of the present invention, every unit within the media processor 100 is connected to every other unit with which the unit needs to communicate via a direct local bus.

As described above, the cross switch 115 connects all units of the media processor 100 in a bidirectional point-to-point interface.

In a preferred embodiment of the present invention the bidirectional point-to-point interface is a wide point-to-point interface, that is, a parallel point-to-point interface with a width of, by way of a non-limiting example, 8 bits, 16 bits, 32 bits, and 64 bits.

In an alternative preferred embodiment of the present invention, the bidirectional point-to-point interface is a serial high-speed bus.

Each unit of the media processor 100 can function as a target unit as well as an initiating unit. As an initiating unit, each unit is designed to transfer commands such as an issue command, a complete command, a read command, and a write command. The cross switch 115 ensures that a unit which is defined as a target unit, receives data from only one associated initiating unit at a time. The cross switch 115 delays, or alternatively, queues, communication from a second initiating unit to the target unit.

The cross switch 115 preferably supports simultaneous communication between more than one pair of target and initiating units. By way of a non-limiting example, a communication session between a pair of units X and Y and a communication session between a pair of units Z and W can be held simultaneously.

The cross switch 115 preferably allows different processing units to communicate with a common unit using time division multiplexing. The cross switch 115 combines multiple communication streams into a single communication stream by separating the single communication stream into many segments, each of the segments having a limited duration. For example, when two units A and B want to communicate with a unit C, the communication stream will be time multiplexed and the unit C will receive a multiplexed signal.

In a preferred embodiment of the present invention, each package of information transmitted by a media processor 100 unit comprises a memory mapped address space. By way of a non-limiting example, each such package comprises an address segment of 16 bits, and a data segment of 32 bits. Part of the address segment may be mapped onto internal configuration registers, microcode memory, data memory, and other components of the target unit.

The duration to complete a request via the cross switch 115 is not limited, nor is it known in advance. In a preferred embodiment of the present invention, the cross switch 115 comprises a queue, to optimize and balance request handling. When an initiating processing unit issues a request, the cross switch 115 may queue the request, as the target of the request may be communicating with another unit, or may be in the middle of a computing task. By way of a non-limiting example, if, during a communication session with a target processing unit, an initiating processing unit communication request targets an address in the target processing unit's internal memory which is currently being accessed by or associated with another unit, or by the target unit, the target unit will delay the execution of the memory access action.

In a preferred embodiment of the present invention, an initiating unit can operate in a normal single-access mode. In a normal single-access mode, the initiating unit issues a single pending command before issuing any other command. The target unit sends a reply to the initiating unit.

In an alternative preferred embodiment of the present invention, the reply is sent as a read or a write completion event.

By way of a non-limiting example, transmitting and receiving of a pending command may be performed in several steps, each of the steps lasting for several computing cycles. At a first step, which preferably consumes one cycle, a single pending command, which is defined as a read/write command, is generated by the initiating unit. Then, during a second step, which preferably consumes (2+X) cycles, the cross switch 115 receives the command and passes it to a designated target unit, where X denotes the cross switch 115 response time, in clock cycles. During a third step, which preferably consumes (1+Y) cycles, the target unit generates and transmits a response to the cross switch 115, where Y denotes the response time of the target unit, in clock cycles. During a fourth step, which preferably consumes one cycle, the cross switch 115 forwards the response to the initiating unit. Thus, by way of the non-limiting example above, a total access time of a single pending command consumes (5+X+Y) cycles. Clearly, the minimum cycle time according to the non-limiting example above, for a single pending command is five cycles, assuming that the cross switch 115 and the target unit can respond immediately, and assuming that the initiating unit issues the single pending command without delay. The method described in the example above reduces arbitration hazards, and reduces variability of the total access time, but the total access time of the method is relatively high.

In a preferred embodiment of the present invention, an initiating unit and the cross switch 115 operate in a pipeline mode. In such a mode, commands are transferred during every clock cycle. When the pipeline mode is implemented, the response time of the cross switch 115 to an active initiating unit may be substantially zero and the response time of the target unit is a constant, which is typically different from zero. By way of a non-limiting example, the response time of the target unit may be 6 cycles.

In order to ensure that the response time of the cross switch 115 is zero, or substantially zero, the initiating unit is designed to send a lock target command *and an unlock target command to the cross switch 115. The lock target command indicates that commands to a specified target unit should only be given from the sending initiating unit and that commands from other initiating units should be delayed until the unlock target command is received from the initiating unit.

It is to be appreciated that, in a manner similar to the communication method which is employed in the normal single-access mode of communication, the pipeline mode of communication between the initiating unit and the target unit can be divided into several steps. When using the pipeline mode, the initiating unit verifies, by using methods well known in the art, such as semaphores, that resources of the target unit are available, and are operative for sending and receiving data.

By way of a non-limiting example, the following six pipelined steps are performed in order to enable an initiating unit to access memory of a target unit. During a first step, the initiating unit issues a new access command to the cross switch 115. During a second step, the access command comprises an address of a segment in the memory of the target unit. During a third step, the cross switch 115 forwards the access command to the target unit. During a fourth step, the target unit accesses its memory according to the address in the forwarded access command. During a fifth step, the target unit transmits data from the memory to the cross switch 115. During a sixth step, the cross switch 115 forwards the data to the initiating unit. Thus, in order to enable the initiating unit to read from the memory of the target unit, a six-step process with a duration of at least six cycles is performed.

Each one of the steps takes an equal amount of time, thereby allowing the initiating unit to transmit an access command in every cycle, in a sequential pipeline method. By using the sequential pipeline method, the duration of each communication session is reduced. Although reading from memory of the target unit takes at least six cycles, after the first reading, new data is received at the initiating unit during every cycle, and an additional access command is transmitted by the initiating unit. In light of the above, it is to be appreciated that the pipeline method is efficient, especially when a large amount of data is to be read.

Data transfer between the media processor 100 and the secure storage unit 119 is implemented via the secure memory controller 116. The processing units of the media processor 100 can transfer data, preferably simultaneously, to and from the secure memory controller 116. The secure memory controller 116 manages a queue of data requests and memory accesses, and a queue of priorities assigned to each access request. Preferably, the secure memory controller 116 comprises hardware dedicated to providing quality-of-service. Preferably, the memory controller 116 automatically allocates memory space and bandwidth appropriate to whichever protocol is used to manage the data transfer.

The secure memory controller 116 preferably encrypts and decrypts data being transferred to and from the secure storage unit 119 in accordance with DRM schemes. Different memory addresses can be assigned different DRM keys. The DRM keys are preferably not constant, as described herein with reference to the secure processor 105, but change according to information which is kept on the secure OTP memory, taken from external security devices such as smartcards, or taken from an on-chip true random number generator.

In a preferred embodiment of the present invention, several secure keys are provided to the secure memory controller 116 by the secure processor 105. The secure memory controller 116 uses the provided keys to produce a new set of keys. The new set of keys is used in the encryption process performed by the secure memory controller 116.

The secure memory controller 116 is operative to communicate with all processing units of the media processor 100, and to securely communicate such information to and from at least one secure storage unit 119 in operative communication with the media processor 100. By way of a non-limiting example, the AV preprocessor 101 can request the secure memory controller 116 to read parts of previously stored video fields or frames from the secure storage unit 119. The multiplexer/demultiplexer 104 can simultaneously request the secure memory controller 116 to write a compressed media stream to the secure storage unit 119 for future playback, as in a personal video recording application.

In a preferred embodiment of the present invention, the secure memory controller 116 comprises a mechanism for secure storage segmentation. Secure storage is preferably divided into virtual segments, and the segments are allocated to the CPU 109 and additional processing units, termed collectively secure storage clients, so that each client is able to access only the segments the client is authorized to access. The segment allocation and access authorization mechanism is preferably implemented and operated by the secure processor 105. Preferably, each time the secure storage is accessed by a client for data read or data write, the access authorization mechanism checks if the client accesses a segment which the client authorized to access, in which case the access is granted. Otherwise the access is blocked, and a security breach warning is issued by the secure memory controller 116 to the secure processor 105.

Each of the units of the media processor 100 can use the secure storage unit 119 for accessing data and for temporary storage. The data accessed can be, by way of a non-limiting example, input data, setup parameters, output data, and so on. The data access is preferably performed via the secure memory controller 116.

The modem 171 can be used to communicate with a satellite dish by transmitting a control signal. The communication is for a purpose of adjusting an amplifier and controlling the satellite dish, and is performed via the RF input 126 and via an RF cable (not shown) connected to the RF input 126 and leading from the media processor 100 to the satellite dish. Possible communication protocols for transmitting the control signal include, by way of a non-limiting example, frequency shift keying (FSK), amplitude shift keying (ASK), phase shift keying (PSK), pulse width modulation (PWM), and a digital satellite equipment control (DiSEqC) protocol. Preferably, the DiSEqC protocol is used, according to consumer satellite control specifications.

In preferred embodiments of the present invention, the modem 171 implements additional communication protocols, using various modulation methods, such as QAM, PSK or FSK. By way of a non-limiting example, one such modulation method is FSK modulation over a 2.3 MHz carrier frequency, as used in DirecTV FTM (Frequency Translator Module) systems.

In an alternative preferred embodiment of the present invention, the modem 171 complies with the DOCSIS Set-top Gateway (DSG), and sends and receives DOCSIS signals and other auxiliary digital information through an RF interface associated with the RF input 126.

In yet another alternative preferred embodiment of the present invention the modem 171 provides a back channel to a satellite, preferably using the DVB-RCS (Digital Video Broadcasting-Return Channel Satellite) standard. In the above-mentioned embodiment, the modem 171 transmits back channel communication via the RF input 126 and via an RF cable (not shown) connected to the RF input 126 and leading from the media processor 100 to the satellite dish.

The media processor 100 also comprises a direct modem output 172, which enables the modem 171 of the media processor 100 to connect to a cable, for communicating via cable modem protocols, to connect to a telephone line, for communicating via telephone line modem protocols, such as, by way of a non-limiting example, a DSL protocol, and to connect to an Ethernet network. It is to be appreciated that alternative preferred embodiments of the modem 171 implement any one of the above-mentioned modem protocols.

The RF receiver 195 described with reference to FIG. 1 is now described in more detail, as comprising the RF tuner 170 and the demodulator 130.

The RF tuner 170 receives an RF signal as input via the one or more RF inputs 126. The RF tuner 170 down-converts the input RF signal frequency from an RF carrier frequency which is generally high, to a lower intermediate frequency signal, which is transmitted to the demodulator 130 via one or more baseband inputs 124. The intermediate frequency is then digitized and further processed by the demodulator 130.

The RF tuner 170 comprises several components, such as, and without limiting the generality of the foregoing, a frequency synthesizer (not shown), and a variable gain amplifier (not shown). The RF tuner 170 preferably receives a feedback gain control signal, via a gain control signal output 125, produced by the demodulator 130.

In an alternative preferred embodiment of the present invention, the media processor 100 comprises one or more base-band inputs 124 connected directly to the demodulator 130, and comprises a gain control signal output 125 providing a gain control signal outside the media processor 100. It is appreciated that the above-mention alternative preferred embodiment provides for a direct baseband input to the media processor 100.

Reference is now made to FIG. 3, which is a simplified block diagram illustration of a demodulator 130 comprised in the media processor of FIG. 2.

The demodulator 130 comprises a timing recovery unit 141, an Automatic Gain Control (AGC) 142, a DC compensation unit 143, a Phase Locked Loop (PLL) unit 144, a sync unit 145, a matched filter unit 146, an Analog to Digital Converter (ADC) 149, and a Forward Error Correction (FEC) unit 160.

The above-mentioned components of the demodulator 130 are all operatively connected to the cross switch 115 (also shown in FIG. 2). The cross switch 115 enables the components of the demodulator 130 to communicate with each other simultaneously, as described with reference to FIG. 2.

Typical operation of the demodulator 130 is now described.

A baseband signal produced by the RF tuner 170 is received by the demodulator 130. In an alternative embodiment of the invention, the demodulator 130 receives the IF signal from an external RF tuner (not shown) through the RF input 124.

The IF or baseband TV signal is acquired by the ADC 149 from the one or more baseband inputs 124, sampled at an appropriate sampling rate, and filtered to remove excess noise in irrelevant frequencies. A resultant digital TV signal is passed to the DC compensation unit 143 which further removes a DC component from the resultant digital TV signal. The signal with DC removed is then transferred to the AGC 142, in which the power of the DC removed signal is estimated, to create a gain signal feedback to the RF tuner 170. The gain control signal is output through the gain control signal output 125. The signal with DC removed is also transferred to the timing recovery unit 141, in which the signal with DC removed is re-sampled. The re-sampling is now performed at a lower rate, which is an integer multiple of an original symbol rate of the received TV signal. The re-sampled signal is then transferred to the matched filter unit 146. The matched filter unit 146 filters the re-sampled signal according to a symbol waveform that was used to transmit the TV signal. The outcome of the matched filter unit 146 is a symbol stream with optimal Signal to Noise Ratio (SNR), sampled at the original symbol rate or an integer multiple thereof. The symbol stream is then transferred to the PLL 144, where any residual frequency and phase, including phase noise, are compensated for. The symbol stream is then transferred both to the sync unit 145 and to the FEC unit 160. The sync unit 145 synchronizes the symbol stream using an a priori known sequence. After the synchronization is accomplished, the FEC unit 160 recovers data, usually encrypted digital transport streams, from the symbol stream. The FEC unit 160 is also capable of error correction and outputting the transport streams at very low Bit Error Rate (BER). By way of a non-limiting example, a very low BER can be 10⁻¹⁰ to 10⁻¹¹.

Components of the demodulator 130 will now be described in more detail.

The ADC 149 converts the analog IF baseband TV signal received from the RF tuner 170 into a digital TV signal.

In an alternative preferred embodiment of the present invention, the media processor 100 comprises an input of a baseband frequency AV stream operatively connected directly to the ADC 149 via one or more baseband inputs 124.

The ADC 149 comprises a plurality of analog to digital converter sub-units, each operative to digitize the IF baseband TV signal. The ADC 149 preferably comprises an effective number of bits (ENOB) depending on which type of TV signal the media processor 100 is designed to receive. In a preferred embodiment of the present invention, the TV signal is an 8PSK signal, and converting the baseband TV signal with 8 bit precision is sufficient. In an alternative preferred embodiment of the present invention, the ADC 149 has 12 bits precision, for receiving 1024 QAM.

The output of the ADC 149 is transmitted through the cross switch 115, or directly (not shown), to the DC compensation unit 143.

The DC compensation unit 143 removes a residual DC component left after the received TV signal has been converted by the ADC 149. In a preferred embodiment of the present invention, the DC compensation unit 143 calculates a value of a DC component for a group of samples of the TV signal. The calculated DC value is fed to a loop filter, and an output of the loop filter is used to deduct the calculated DC value from each new sample received from the ADC 149.

An output of the DC compensation unit 143 is transmitted through the cross switch 115, or directly (not shown), to the AGC 142 and to the timing recovery unit 141.

The AGC 142 dynamically controls an adaptive gain amplifier (not shown) comprised in the RF tuner 170, by providing a feedback gain control signal, via the gain control signal output 125, to the RF tuner 170, in order to allow full utilization of the dynamic range of the ADC 149.

In a preferred embodiment of the present invention, the AGC 142 measures the power of the output of the DC compensation unit 143, and produces an adaptive output to the RF tuner 170. If the power is too strong, the gain of the RF tuner 170 is decreased so that the received IF baseband signal will not be saturated. If the power is too weak, the gain of the RF tuner 170 is increased, to increase dynamic range of the received IF baseband signal. The AGC 142 typically has a substantially stable output, since the received IF baseband power level typically changes very slowly, if at all.

The purpose of the timing recovery unit 141 is to recover one sample, or an integer multiple of one sample, for every transmitted symbol. It is to be appreciated that usually, even if a symbol rate is known to a receiver, the receiver does not know when to sample a signal in order to achieve maximum Signal to Noise Ratio (SNR).

A communication system usually requires only one sample per symbol to represent a received signal without loss of information.

The timing recovery unit 141 preferably interpolates and re-samples the signal with DC removed output by the DC compensation unit 143, in order to calculate a sample rate which is an integer multiple of a symbol rate used in the original input TV signal.

In a preferred embodiment of the present invention, the timing recovery unit 141 samples the signal with DC removed at a rate greater than two times the rate of the baseband frequency signal. The timing recovery unit 141 processes the samples in order to get an integer multiple of the transmitted symbol rate. The samples produced by the timing recovery unit 141 are then transmitted to a matched filter unit 146 in order to achieve a symbol sample with a substantially maximal SNR.

In a preferred embodiment of the present invention, timing recovery is implemented by estimation from a block of samples, in order to determine optimal sampling times.

In an alternative preferred embodiment of the present invention, a timing loop which continuously tracks timing of the received TV signal is used. An example of such a timing loop is a Gardner algorithm, as is well-known in the art. The timing recovery unit 141 outputs samples at an average rate approximately equal to a symbol rate of the transmitted signal or to an integer multiple thereof. Jitter around the symbol rate is typically allowed.

In a preferred embodiment of the present invention, an estimation of the SNR of the input signal is used to set a bandwidth for synchronization loops comprised in the demodulator 131, such as, by way of a non-limiting example, the timing recovery unit 141 and the PLL unit 144. As the SNR increases, the bandwidth of the synchronization loops is increased, providing better tracking performance and shorter convergence times.

The output of the timing recovery unit 141 is transmitted through the cross switch 115, or directly (not shown), to the matched filter unit 146.

The matched filter unit 146 extracts a symbol energy found in a plurality of samples of the input TV signal. The matched filter unit 146 has a filter response shape which is matched to a pulse shape of a symbol at a transmitter.

In a preferred embodiment of the present invention, the matched filter unit 146 implements a function which is a Square Root Raised Cosine (SRRC), as is known in the art of matched filter design.

In the matched filter unit 146, a roll off factor, also termed alpha or beta, determines an amount of excessive bandwidth for the pulse shape. By filtering a received signal with a matched filter and sampling at a symbol rate of the received signal, a rate of a single sample per symbol is achieved.

Output produced by the matched filter unit 146 is transmitted through the cross switch 115, or directly (not shown), to the PLL 144.

In an alternative preferred embodiment of the present invention output produced by the matched filter unit 146 is transferred to the FEC unit 160.

The PLL unit 144 receives input from the matched filter unit 146 and removes any residual frequency and phase from the input. In a preferred embodiment of the present invention, removal of residual frequency is performed in several steps. A first step is to perform coarse frequency estimation in order to allow the timing recovery unit 141 to work well. In a second step, fine frequency estimation is done and the PLL unit 144 removes any residual frequency and phase.

In a preferred embodiment of the present invention, the PLL unit 144 uses a Numerically Controlled Oscillator (NCO) to produce a signal which tracks the phase of an input signal. A phase detector (not shown) comprised in the PLL unit 144 measures a difference between the NCO signal and the input signal. An error generated by the phase detector is filtered by a loop filter (not shown) and further drives the loop filter to track a phase of the input signal. The order and values of the loop filter strongly affect performance of the PLL unit 144. Higher order loop filters are used to track varying dynamics between the transmitter and receiver.

Output produced by the PLL unit 144 is passed to the FEC unit 160, and to the sync unit 145, either through the cross switch 150, or directly (not shown).

The sync unit 145 receives input from PLL unit 144 and synchronizes the input to a known element, such as, by way of a non-limiting example, a start of a frame sequence.

In a preferred embodiment of the present invention, the sync unit 145 searches for a start of a frame sequence, enabling synchronization of the decoder 130 to an incoming symbol stream.

In an alternative preferred embodiment of the present invention, the sync unit 145 determines phase ambiguities in the output produced by the PLL unit 144.

The sync unit 145 provides output to the FEC unit 160, either through the cross switch 150, or directly (not shown). In an alternative preferred embodiment of the present invention the FEC unit 160 receives output produced by the matched filter unit 146.

The FEC unit 160 removes redundant data which is embedded in the TV signal, and performs error correction, using the redundant data.

To reduce a Bit Error Rate (BER) associated with a signal, a transmitter normally encodes a signal representing K bits, using a signal carrying N bits, where N>K. The encoding results in a code rate of K/N<1.

The process of decoding the received signal and performing error correction typically involves Forward Error Correction (FEC). In TV broadcast, FEC is usually performed by concatenating of two codes such as, by way of a non-limiting example, concatenating a convolution code and Reed Solomon code, or concatenating Low Density Parity Check (LDPC) and Bose, Ray-Chaudhuri, Hocquenghem (BCH). Furthermore, FEC usually comprises an interleaver. Interleaving encoded symbols provides a form of time diversity which protects against short-duration data corruption and short bursts of errors.

Traditional interleaving strategy known in the art is typically independent of which FEC scheme is used, except when the concatenated FEC schemes are used. In case of a concatenated FEC scheme, interleaving parameters are carefully selected to match the error correcting capabilities of the schemes involved. Recently, interleavers, which are well known in art, have become an integral part of code design. Such is the case for Turbo and Turbo-like codes.

There are two major types of FECs known in the art: block coding and convolution coding. Block coding operates on fixed-size blocks (packets) of bits or symbols of a predetermined size. Convolution coding operates on bit or symbol streams of arbitrary length. There are many types of block codes, but most frequently used coding in the art is Reed-Solomon (RS) coding, due to its widespread use in CD, DVD and computer HDDs. Golay, BCH and Hamming codes are other examples of block codes. Nearly all block codes apply algebraic properties of finite fields.

In a preferred embodiment of the present invention, the FEC unit 160 generates a Bit-Error Rate (BER) value, which is used as feedback to fine-tune units such as the timing recovery unit 141 and the PLL unit 144.

In a preferred embodiment of the present invention, a Viterbi FEC algorithm is employed, the FEC unit 160 processes quasi-analog data, represented in a quantized fashion, and the FEC unit 160 outputs digital data. Such a FEC is known in the art and termed a soft decision FEC.

In a preferred embodiment of the present invention, the FEC unit 160 typically examines tens, or even hundreds, of previously received bits to determine how to decode a current bit or a current small group of bits, typically 2 to 8 bits.

In a preferred embodiment of the present invention, the FEC unit 160 implements FEC based on a concatenation of two codes, such as, by way of a non-limiting example, the RS coding and convolution coding, and concatenation of BCH coding and LDPC coding. An outer code usually removes any residual error left by an inner code.

In a preferred embodiment of the present invention, LDPC coding removes most of the errors present at the receiver while BCH block coding removes a remaining, known in the art, error floor of the LDPC code.

The output of the FEC unit 160 is usually one or more compressed media streams. The compressed media streams are typically also encrypted.

The output of the FEC 160 unit is typically transferred through the cross switch 115, or directly (not shown) to the secure processor 105 (FIG. 2).

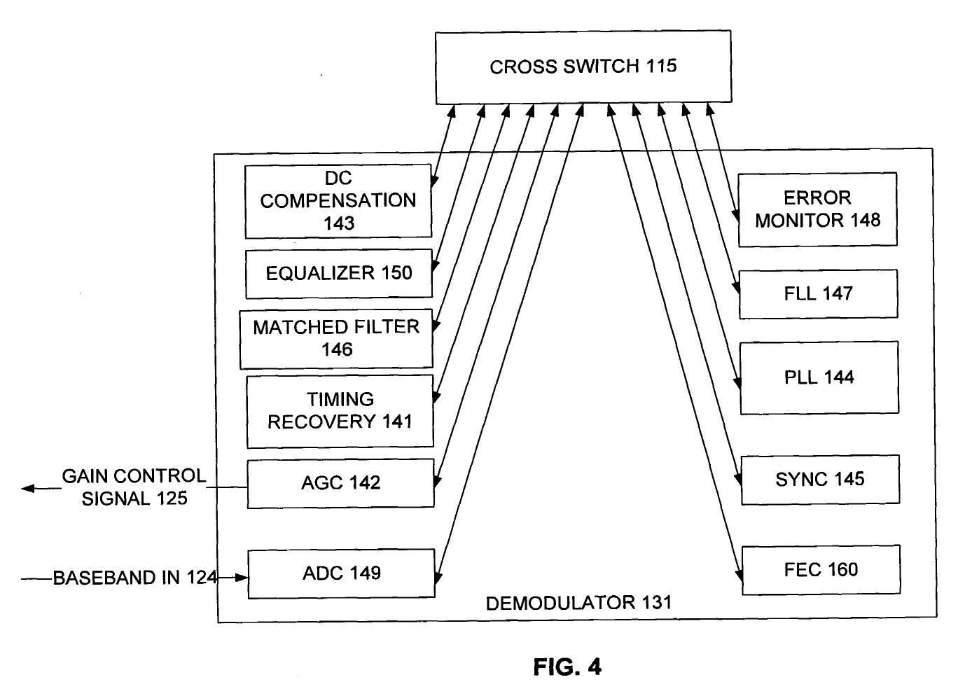

Reference is now made to FIG. 4, which is a simplified block diagram illustration of an alternative preferred embodiment of the demodulator comprised in the media processor of FIG. 2.

FIG. 4 depicts a demodulator 131 comprising the timing recovery unit 141, the AGC 142, the DC compensation unit 143, the PLL unit 144, the sync unit 145, the matched filter unit 146, an equalizer 150, a Frequency Locked Loop (FLL) unit 147, an error monitor 148, the ADC 149, and the FEC unit 160. Components of the demodulator 131 are all operatively connected to the cross switch 115. The cross switch 115 enables the components of the demodulator 131 to communicate with each other simultaneously, as described with reference to FIG. 2 and FIG. 3.

The timing recovery unit 141, the AGC 142, the DC compensation unit 143, the PLL unit 144, the sync unit 145, the matched filter unit 146, the ADC 149, and the FEC unit 160 are the same and operate as described above with reference to FIG. 3.

The operation of the equalizer 150, the FLL unit 147, and the error monitor 148 is described below.

The equalizer 150 receives input from the timing recovery unit 141, and removes channel signal distortions from the input.

In an alternative preferred embodiment of the present invention the equalizer 150 receives input from the matched filter unit 146.

Generally, information-bearing signals transmitted between remote locations encounter a signal-altering physical channel. Non-limiting examples of such signal altering transmissions include transmissions through coaxial cable, fiber optic cable, twisted-pair cable, the atmosphere, and the ocean. Each of these physical transmission channels can cause signal distortion, including echoes and frequency-selective filtering of the transmitted signal. One important manifestation of signal distortion which the equalizer 150 corrects is referred to as Inter Symbol Interference (ISI), whereby symbols transmitted before and after a given symbol corrupt detection of the given symbol. All physical channels at high data rates tend to exhibit ISI.

In a preferred embodiment of the present invention the equalizer 150 implements linear channel equalization. Implementation of linear channel equalization is well known in the art, and commonly used to counter effects of linear channel distortion. The equalizer 150 attempts to extract transmitted symbol sequences by counteracting the effects of ISI, thereby improving a probability of correct symbol detection.

In an alternative preferred embodiment of the present invention the equalizer 150 implements blind equalization.

Implementing blind equalization is also well known in the art. Since it is common for channel characteristics to be unknown, by way of a non-limiting example, at startup, and for channel characteristics to change over time, the equalizer 150 is adaptive in nature. Typical equalization techniques known in the art employ a time-slot, recurring periodically for time-varying situations, during which a training signal, known in advance by the receiver, is transmitted. Utilizing a time slot for a training sequence results in overhead, a reduction in useful bit rate, and is not always present. A process of equalization without using a training sequence is known in the art as blind equalization. Blind equalization is usually employed in DTV broadcast receivers.

In yet another preferred embodiment of the present invention, the equalizer 150 works on symbols arriving at a transmitted symbol rate produced by the timing recovery circuit 141. There is a plurality of algorithms known in the art for updating coefficients of the equalizer 150 with various properties of Signal to Noise Ratio (SNR) loss, and time of convergence.

In yet another preferred embodiment of the present invention, the equalizer 150 operates on more than one sample per symbol. This type of equalizer is known in the art and termed a fractionally spaced equalizer. The fractionally spaced equalizer has been shown to be better than a symbol spaced equalizer in some specific applications. One important feature of the fractionally spaced equalizer is that the fractionally spaced equalizer is insensitive to timing phase errors and can actually counteract such errors.

The output of the equalizer 150 unit is transmitted through the cross switch 115, or directly (not shown), to the FLL unit 147.

The error monitor unit 148 receives input from the FEC unit 160, the PLL unit 144, the FLL unit 147, the sync unit 145, and the equalizer unit 150, through the cross switch 115, or directly (not shown). The error monitor unit 148 monitors performance of the demodulator 130, and analyzes incoming signal characteristics.

In a preferred embodiment of the present invention, the error monitor 148 estimates a number of errors by comparing a valid constellation symbol, determined from a single input entering an error correcting block, such as, by way of a non-limiting example, an LDPC or BCH, with a respective output symbol of the error correcting block. The comparison of a systematic part of a codeword yields a count of errors if the error correcting block output is errorless, the count of errors being in inverse proportion to the SNR of the input signal.

In a preferred embodiment of the present invention, output produced by the matched filter unit 146 is transferred to an FLL 147.

In an alternative preferred embodiment of the present invention output produced by the matched filter unit 146 is transferred directly to the FEC unit 160. The output of the matched filter unit 146 is transmitted through the cross switch 115, or directly (not shown), to the FLL unit 144.

The FLL unit 147 removes residual frequency from the input. In a preferred embodiment of the present invention, the removal of residual frequency is performed in several steps. A first step is to perform a coarse frequency estimation, in order to allow the timing recovery unit 141 to work well. In a second step, a fine frequency estimation is performed, and the FLL unit 147 is responsible for removal of any residual frequency.

In a preferred embodiment of the present invention, the FLL unit 147 comprises a Numerically Controlled Oscillator (NCO) (not shown), used to produce a signal which tracks a frequency of the incoming signal. A frequency detector (not shown) measures a difference between a frequency of the NCO signal and the frequency of the incoming signal. An error signal generated by the frequency detector is filtered by a loop filter and further drives the loop filter to track the frequency of the incoming signal. The order and values of the loop filter strongly affect the performance of the FLL unit 147. Higher order loop filters are required to track varying dynamics between a transmitter and a receiver.

In an alternative preferred embodiment of the present invention, the FLL unit 147 estimates the phase and frequency of the incoming signal by maximum likelihood estimation.

In a preferred embodiment of the present invention, the FLL unit 147 is connected directly (not shown), or, through the cross switch 115, to the PLL unit 144. The output of the FLL 147 is transmitted through the cross switch 115, or directly (not shown), to the PLL unit 144. The PLL 144 unit is connected through the cross switch 115, or directly (not shown), to the FEC unit 160.

In another preferred embodiment of the present invention, output produced by the FLL unit 147 is passed directly to the FEC 160.

Applications using the media processor 100 will now be described.

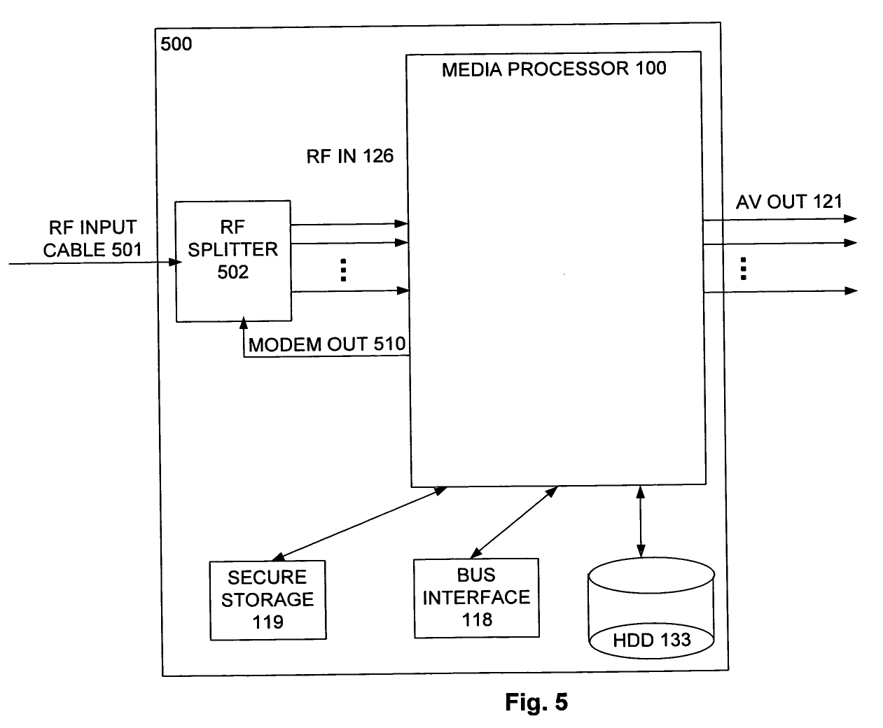

Reference is now made to FIG. 5, which is a simplified block diagram illustration of an advanced digital set top box 500 comprising the media processor 100 of FIG. 1.

The advanced digital set top box 500 comprises the media processor 100, the HDD 133, the bus interface 118, and the secure storage unit 119, as described above with reference to FIG. 2.

An RF input cable 501 provides input of an RF signal to the advanced digital set top box 500. The RF input may be from a digital cable connection, or from a digital satellite receiving dish. Within the advanced digital set top box 500 an RF splitter 502 splits the RF input, producing one or more RF inputs 126, as described above with reference to FIGS. 1, 2, and 3. The one or more RF inputs 126 are provided to the media processor 100, which preferably receives and processes one or more media streams, producing one or more output video streams through the uncompressed digital and analog AV output interfaces 121, as described above with reference to FIG. 2. The output video streams are output to client stations such as, by way of a non-limiting example, analog TVs, digital TVs, CE (consumer electronic) appliances such as Video Cassette Recording (VCR) systems, DVD recorders, and so on. A modem output 510 preferably connects the modem output 172 of FIG. 2 to the RF splitter 502.

Persons skilled in the art will appreciate that the RF splitter 502 is comprised within the advanced digital set top box, but can also be a separate unit external to the advanced set top box 500. If the RF splitter is external, the advanced set top box 500 supports connecting one or more RF input cables 501, and the modem output 510, by separate connections (not shown).

It is to be appreciated that the media processor 100 processes, decrypts, indexes, stores, demultiplexes, decodes, post-processes, blends and produces composite display outputs simultaneously for a plurality of input media streams. Each one of the input media streams may comprise compressed video and audio signals, and still images, in parallel.

It is to be appreciated that the advanced digital set top box 500 of FIG. 5 is what is presently termed a home gateway system.

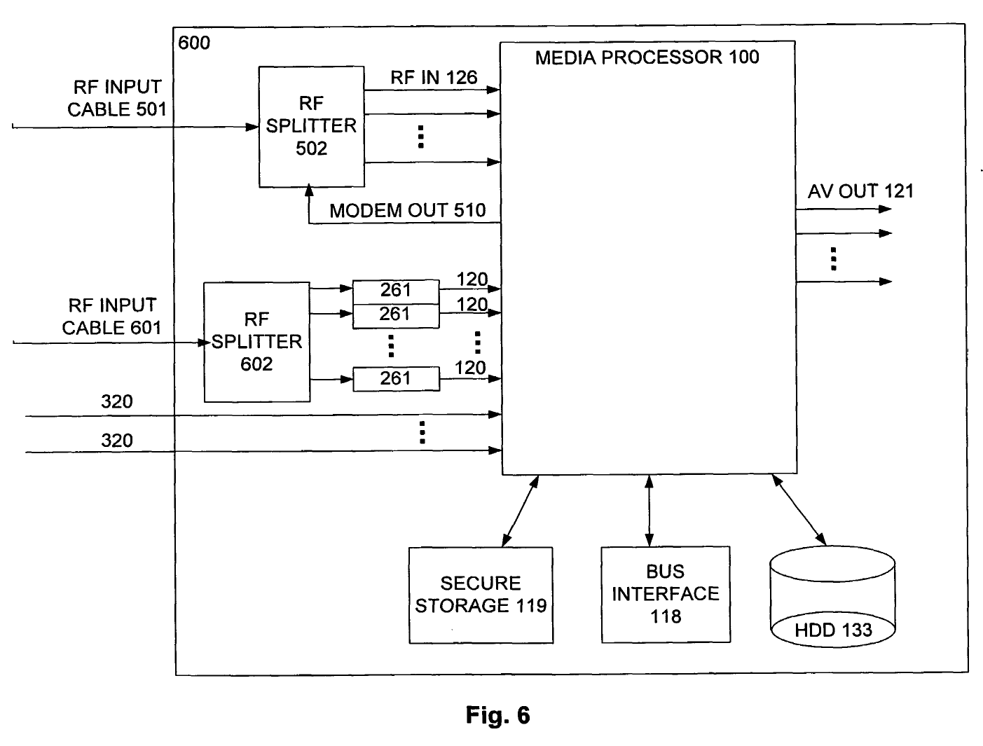

Reference is now made to FIG. 6, which is a simplified block diagram illustration of an advanced set top box 600 combining analog and digital inputs, and comprising the media processor 100 of FIG. 1.

The media processor 100, the secure storage unit 119, the bus interface 118, and the HDD 133 are as shown in FIG. 5 above. However, FIG. 6 further depicts a plurality of additional analog receivers 261 and one or more analog AV inputs 320.

The analog AV inputs 320, allow the media processor with TV receiver 100 to receive a number of uncompressed media streams from external AV sources such as a VCR, a camcorder, and other Consumer Electronic (CE) appliances. Moreover, the media processor 100 is also used to playback multiple analog TV channels which are received through the analog receivers 261 and transferred to the uncompressed digital and analog AV input interface 120 of the media processor 100.

The digital media streams provided through the RF inputs 126 are usually encrypted, and, by way of a non-limiting example, may be transferred to the HDD 133 for storage. Such an HDD 133 allows a user to use the advanced digital set top box 600 as a Personal Video Recorder (PVR). Sequentially, or simultaneously, media streams are also read from the HDD 133 and transferred to the media processor 100, which decrypts, demultiplexes, decodes, post-processes, blends, and renders for display one or more of the media streams in either normal or trick play mode. As described above, media streams can include media streams which are several streams blended together, single streams blended with graphics planes and still images, and more than one stream blended together with graphics planes and/or still images.

An additional non-limiting example application of the media processor 100 comprises a digital TV, preferably defined according to advanced television systems committee (ATSC) standards, comprising optional digital cable support, which is preferably defined according to open cable application platform (OCAP) standards. Preferably, the digital TV comprises an embedded personal video recorder.

Reference is made again to FIG. 6, in which the media processor 100, the secure storage unit 119, the bus interface 118, the HDD 133, and the analog AV inputs 320 are as described above. A digital satellite, cable or terrestrial TV signal is received through an RF input cable 501, and is transferred to the RF inputs 126 of the media processor 100 via the RF splitter 502. The digital transport streams retrieved from the digital terrestrial TV signals are preferably (a) decrypted, indexed, re-encrypted, and stored, preferably on HDD 133, for future use, or (b) decrypted, demultiplexed, decoded, post-processed, blended and displayed.

Additionally and in parallel, an analog cable or terrestrial TV signal is received through an RF input cable 601. An RF splitter 602 splits the RF signal into multiple analog RF TV signals that are fed into analog RF receivers 261. The analog RF receivers 261 produce uncompressed AV streams which are fed to the uncompressed digital and analog AV input interfaces 120 of the media processor 100.

Additionally and in parallel, a number of AV inputs 320 are deployed. The AV inputs 320 may support conventional video connections such as an HDMI connection, DVI connection, Component/RGB connection, S-video connection, composite connection or a combination thereof. The AV inputs may also support regular audio connections such as HDMI with HDCP connection, Sony/Philips Digital Interface Format (S/PDIF) connection, baseband audio connection, BTSC (Broadcast Television Systems Committee) audio, and so on.

The uncompressed AV signal received from AV inputs 320 and from analog RF receivers 261 are preferably pre-processed, post-processed, blended with additional graphics, data, still image and video planes and rendered for display.

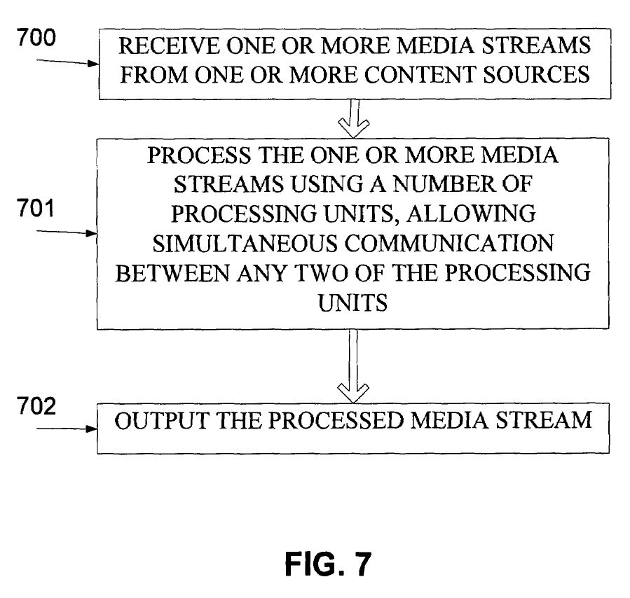

Reference is now made to FIG. 7, which is a flowchart of an exemplary method for processing one or more media streams, according to a preferred embodiment of the present invention. During a first step 700, one or more media streams are received from one or more content sources. The TV signals and data streams are preferably received at the media processor 100 (FIGS. 1, 2, 5, and 6), or at a consumer electronics (CE) appliance connected to the media processor 100, such as, by way of a non-limiting example, a HD-DVD, a Blu-Ray player, a personal video recorder, a place-shifting TV, and a digital TV.

The media processor 100 enables execution of one or more of the following operations in parallel on one or more of the received media streams, (step 701):

tuning, digitizing, demodulation and decoding of TV signals;

45 decrypting, indexing, demultiplexing, decoding, post-processing and blending of media streams; and

executing a plurality of real-time operating system tasks.

During step 702, the processed media streams, which are either compressed or uncompressed, and represented in digital or analog form, are output to storage, to transmission, or to a display or a sound device. The media processor 100 allows a number of storage, transmission or display devices to receive the processed media stream or derivative thereof, and allows a number of users to simultaneously access different media channels.

An additional exemplary preferred embodiment of the present invention is a decoder with an embedded cable/satellite/terrestrial TV receiver implementation comprising the following units:
AV Preprocessor 101
Video decoder 102
Entropy decoder 103
Multiplexer/demultiplexer 104
Secure processor 105
Audio ENDEC 106
Still image ENDEC 108
CPU 109
Secure Peripheral Module 110
2D/3D Graphics Engine/Blender 111
AV Postprocessor 112
Secure AV output 114
Cross switch 115
Secure Memory Controller 116
RF tuner 170
Modem 171
Timing recovery unit 141
AGC 142
DC compensation unit 143
PLL unit 144
Sync unit 145
ADC 149
FEC unit 160

A person skilled in the art will appreciate that the media processor 100 can be installed in many kinds of electronic devices associated with media processing, including, by way of a non-limiting example, a digital TV, a Digital Versatile Disk (DVD) player or recorder, High Definition DVD (HD-DVD) player or recorder, Blu-Ray player or recorder, cellular telephones, portable electronic devices of various kinds including portable TV receivers, portable video players, portable audio players, video conferencing equipment, broadcast equipment, video surveillance equipment, cable/satellite/terrestrial set-top boxes and home media gateways, Internet Protocol TV (IPTV) terminals & equipment, PCs, workstations and servers, consumer electronic devices and PC appliances, personal video recorders, play-shift TV, wireless TV, location free TV, 2-piece TV and the like.

It is expected that during the life of this patent many relevant devices and systems will be developed and the scope of the terms herein, particularly of the terms media processor, stream, communication, and home gateway are intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. An integrated circuit for processing a media stream, comprising integrally as a single unit:
an RF input interface;
an RF receiver unit configured for receiving an RF media stream from the RF input interface and extracting the media stream from the RF media stream;
an input interface unit configured for receiving the media stream from a content source;
a plurality of processing units configured to simultaneously process the media stream;
a switch, operatively connected to the RF receiver unit, to the input interface, and to each of the processing units, the switch configured to allow more than one of the operatively connected units to simultaneously receive the media stream and to simultaneously communicate with each other; and
an output interface, operatively connected to the switch, configured to receive the processed media stream from the switch, and to output the processed media stream;

2. The integrated circuit of claim 1 and wherein the input interface unit comprises a plurality of input interfaces.

3. The integrated circuit of claim 1 and wherein the output interface comprises a plurality of output interfaces.

4. The integrated circuit of claim 1, and wherein one of the plurality of processing units comprises a secure memory controller configured for controlling at least a portion of memory being accessed as secure memory.

5. The integrated circuit of claim 4 and wherein the secure memory controller is configured for encrypting data transfer to and from an external memory device.

6. The integrated circuit of claim 4 and wherein the secure memory controller comprises a mechanism configured for secure storage segmentation.

7. The integrated circuit of claim 4 and wherein at least a portion of the secure memory is comprised in the integrated circuit, and the portion of the secure memory comprised in the integrated circuit is protected by implementing measures of hardware protection thereof.

8. The integrated circuit of claim 5, and wherein the encrypting is configured to be carried out according to a DRM scheme, and wherein the integrated circuit is configured to generate DRM keys using at least one of a group comprising: a pseudo-random number generator and a true random number generator.

9. The integrated circuit of claim 5, and wherein the encrypting is configured to be carried out according to a DRM scheme, and wherein the integrated circuit is configured to store DRM keys in at least one member of a group comprising: a secure embedded one-time programmable memory, a software application, and an external device.

10. The integrated circuit of claim 5, and wherein the encrypting is configured to be carried out according to a plurality of DRM keys.

11. The integrated circuit of claim 4, and wherein the secure memory controller comprises a storage device.

12. The integrated circuit of claim 1, and wherein the switch comprises a bidirectional point-to-point connection between each of the operatively connected units.

13. The integrated circuit of claim 12, and wherein the bidirectional point-to-point connection comprises a wide parallel connection.

14. The integrated circuit of claim 12, and wherein the bidirectional point-to-point connection comprises a high speed serial connection.

15. The integrated circuit of claim 1, and wherein the switch is configured to operate in pipeline mode.

16. The integrated circuit of claim 1, and wherein the switch is configured to enable two or more of the processing units to simultaneously receive at least two different media streams.

17. The integrated circuit of claim 1, and wherein at least one of the plurality of processing units is configured to perform one of a group consisting of: decoding the media stream according to a compression algorithm, and compressing the media stream according to a compression algorithm.

18. The integrated circuit of claim 17, and wherein at least one of the plurality of processing units is configured for preprocessing the media stream before the media stream is rendered or displayed, and wherein the preprocessing comprises a member of a group consisting of: image up-scaling, image down-scaling, spatial filtering, temporal filtering, linear filtering, non-linear filtering, and reducing digital and analog noise of the media stream.

19. The integrated circuit of claim 1, and wherein at least one of the plurality of processing units is configured to demultiplex the media stream into one or more media streams, and multiplex the media stream with an additional media stream.

20. The integrated circuit of claim 1, and wherein the switch comprises an external device connection, the switch being configured to simultaneously receive an additional media stream via the external device connection.

21. The integrated circuit of claim 1, and wherein the switch is configured to allow simultaneous communication between two or more of the plurality of processing units and one other of the processing units.

22. The integrated circuit of claim 21, and wherein the switch is configured to enable the simultaneous communication by performing time division multiplexing of the communication.

23. The integrated circuit of claim 1, and wherein at least one of the plurality of processing units is configured to perform one of a group consisting of: decrypting the media stream, and encrypting the media stream.

24. The integrated circuit of claim 1, and wherein at least one of the plurality of processing units is configured for post-processing the media stream, and the post-processing comprises implementing a member of a group consisting of: performing image processing on the media stream, up-scaling images in the media stream, down-scaling images in the media stream, performing color format conversion of images in the media stream, performing edge enhancement in images in the media stream, reducing noise in the media stream, de-blocking the media stream, de-ringing the media stream, de-interlacing the media stream, frame rate conversion, frame interpolation, image de-blurring, dithering, moire cancellation, and digital contour removal.

25. The integrated circuit of claim 1, and wherein the plurality of processing units comprises a member of a group consisting of: an audio/video (AV) preprocessor, a video decoder, an entropy decoder, a data demultiplexing processor, a secure processor, an audio ENDEC processor, a still image ENDEC processor, an embedded CPU, a 2D/3D graphics engine/blender, and an AV postprocessor.

26. The integrated circuit of claim 1, and wherein at least one of the processing units is configured for adding Digital Rights Management (DRM) onto the media stream.

27. A method for providing a processed media stream, comprising:
receiving an RF input from an RF content source;
tuning and demodulating the RF input to produce a media stream;
providing the media stream to a plurality of processing units;
enabling the plurality of processing units to simultaneously process the media stream;
enabling simultaneous communication between any two of the plurality of processing units; and
outputting the processed media stream.

28. The method of claim 27, and wherein each one of the plurality of processing units is configured to communicate with another of the plurality of processing units via a switch having a capacity and a configuration to handle a plurality of media streams simultaneously.

29. The method of claim 28 and wherein the switch comprises a bidirectional point-to-point connection between each of plurality of processing units.

30. The method of claim 29, and wherein the bidirectional point-to-point connection comprises a wide parallel connection.

31. The method of claim 29, and wherein the bidirectional point-to-point connection comprises a high speed serial connection.

32. The method of claim 28, and wherein the switch operates in pipeline mode.

33. The method of claim 27 and wherein the tuning and demodulating produces a plurality of media streams.

34. The method of claim 27, and wherein the providing comprises simultaneously providing the plurality of media streams.

35. The method of claim 27, and wherein the processing of the media stream comprises one of a group consisting of: decoding the media stream according to a compression method, and compressing the media stream according to a compression algorithm.

36. The method of claim 27, and wherein the processing of the media stream comprises preprocessing the media stream using at least one of the plurality of processing units, and wherein the preprocessing comprises a member of the group consisting of: down-scaling, up-scaling, spatial filtering, temporal filtering, linear filtering, nonlinear filtering, and analog and digital noise reduction of the media stream.

37. The method of claim 35, and wherein the processing of the media stream comprises determining the compression method.

38. The method of claim 27, and wherein the processing of the media stream comprises performing at least one of the group consisting of: de-multiplexing the media stream into one or more media streams, and multiplexing the media stream with an additional media stream.

39. The method of claim 27, and further comprising:
receiving an additional media stream from an external device; and
combining the additional media stream with the media stream.

40. The method of claim 27, and further comprising:
generating a time multiplexed stream based, at least partly, on outputs of two or more of the plurality of processing units; and
transferring the time multiplexed stream to another of the plurality of processing units, thereby enabling the two or more of the plurality of processing units to simultaneously communicate with the another of the plurality of processing units.

41. The method of claim 27, and wherein the processing of the media stream comprises post-processing the media stream using at least one of the plurality of processing units, and wherein the post-processing comprises a member of a group consisting of: image processing of the media stream, up-scaling of images in the media stream, down-scaling images in the media stream, performing color format conversion of images in the media stream, performing edge enhancement in images in the media stream, reducing noise in the media stream, de-blocking the media stream, de-ringing the media stream, de-interlacing the media stream, frame rate conversion, frame interpolation, image de-blurring, dithering, moire cancellation, and digital contour removal.

42. The method of claim 27, and wherein the processing of the media stream comprises adding Digital Rights Management (DRM) onto the media stream.

43. The method of claim 27, and wherein the processing of the media stream comprises performing one of the group consisting of: decrypting and encrypting the media stream using at least one of the plurality of processing units.

44. A digital television system comprising:
an integrated circuit comprising:
an RF receiver configured to receive an RF signal comprising a media stream, and to produce a digital media stream;
a plurality of processing units operatively connected to the RF receiver, configured for simultaneously processing the digital media stream;
a switch, operatively connected to each of the plurality of processing units and to the RF receiver, configured to enable more than one of the operatively connected processing units to simultaneously receive the media stream; and
an output interface operatively connected to the switch for outputting the simultaneously processed digital media stream.

45. The digital television system of claim 44, and wherein the RF receiver is configured to produce a plurality of digital media streams.

46. The digital television system of claim 44, and wherein the simultaneously processing the digital media stream comprises simultaneously processing a plurality of digital media streams.

47. The digital television system of claim 44, and wherein the outputting the simultaneously processed digital media stream comprises outputting a plurality of simultaneously processed digital media streams.

48. The digital television system of claim 44, and wherein the switch comprises a bidirectional point-to-point connection between each of plurality of processing units, the RF receiver, and the output interface.

49. The digital television system of claim 48, and wherein the bidirectional point-to-point connection comprises a wide parallel connection.

50. The digital television system of claim 48, and wherein the bidirectional point-to-point connection comprises a high speed serial connection.

51. The digital television system of claim 44, and wherein the switch operates in pipeline mode.

52. The digital television system of claim 44, and further comprising a display unit operative to display the simultaneously processed digital media stream.

53. The digital television system of claim 44, and further comprising a personal video recorder unit configured to store the simultaneously processed digital media stream.
